(19) United States
(12) Patent Application Publication
(10) Pub. No.: US 2014/0192995 A1
(43) Pub. Date: Jul. 10, 2014

(54) Ear Bud Retraction Module Having Optimal Microphone Placement

(71) Applicants: John Cataldo, Westlake Village, CA (US); Daniel C. Sullivan, Santa Barbara, CA (US); Mardis Bagley, San Francisco, CA (US)

(72) Inventors: John Cataldo, Westlake Village, CA (US); Daniel C. Sullivan, Santa Barbara, CA (US); Mardis Bagley, San Francisco, CA (US)

(73) Assignee: HEADLOGIC LLC, Westlake Village, CA (US)

(21) Appl. No.: 13/733,886

(22) Filed: Jan. 4, 2013

(51) Int. Cl. H04R 1/10

(52) U.S. Cl. CPC H04R 1/1033
USPC 381/74; 381/380

(57) ABSTRACT

A retractable ear bud module has a housing with an ear bud cable retractable mounted in the housing. The ear bud cable has at least one ear bud and a microphone, and a fixed end attached to a circuit board including a wireless receiver mounted. The wireless receiver electronically connects with the ear bud cable to transfer audio signals from the electronic device to the ear bud and from the microphone to the wireless receiver. A spool, mounts in the housing to retract and dispense the ear bud cable. In order to avoid entanglement of the microphone in the spool and housing, the microphone is integrated with the ear bud in one embodiment, is collocated with the ear bud in an alternate embodiment, and is distanced by no more than two inches from the ear bud in another embodiment.

### RELATED APPLICATIONS

This patent application relates in subject matter to commonly assigned U.S. patent application Ser. No. 13/621,332, filed 17 Sep. 2012, and U.S. patent application Ser. No. 13/733,574, filed 3 Jan. 2013, and U.S. patent application Ser. No. 13/733,630, filed 3 Jan. 2013, the disclosures of which is incorporated herein by reference.

### FIELD OF THE INVENTION

The present invention relates to ear bud management mechanisms that dispense and retract ear bud cables.

### BACKGROUND OF THE INVENTION

Ear buds are devices that attach to the ear or head of a user to deliver sound directly to the ear in a personal way. Ear buds may attach to the pinna, lobule, or insert within the external auditory canal. Ear buds may also hang from the head and cover a portion of the ear. The sound delivered typically can be heard by the user, but others have difficulty hearing at the typical sound volume delivered.

One benefit of using ear buds is that an electronic device may be distanced from a user's ear to minimize electro-magnetic fields, which are known to impair the electrical fields in the brain, sometimes causing headaches or heat buildup in the head. Another benefit is to minimize interference with ambient sounds. Yet another benefit is to minimize eavesdropping. Since an ear bud need not be held by a user, this frees the hands for other activities.

Ear buds are commonly used with telephones, music players, computers and other portable, and non-portable, electronic devices.

One major drawback of using wired ear buds with electronic devices is cord management. Cord management is a commonly experienced problem where the cord of the ear buds becomes tangled. Ear bud cords may be damaged by a frustrated user who attempts to hastily untangle the cord. Operating an automobile or other vehicle while experiencing cord management problems can be dangerous. What is desired is a better way of cord management which enables the user to readily extend and retract ear bud cables in an easy and reliable manner.

U.S. Pat. No. 7,599,509 to Ito discloses an input cord used in a headphone apparatus, and a reel retracts and dispenses ear buds. However, there is no microphone for use with a telephonic handset.

U.S. Pat. No. 8,284,981 to Cataldo discloses a retractable ear bud mechanism having a microphone attached to the ear bud cables. However, placement of such a microphone on the ear bud cables can bind within the spool that retracts and dispenses the cables.

While the state of the art shows a trend toward convenience of use of ear buds with electronic devices and cases for electronic devices, there is also a lack of effective ways for managing ear bud cables having microphones. What is desired is an ear bud management system, which enables the use of a microphone that will not bind during retraction and dispensation of ear bud cables.

### SUMMARY OF THE INVENTION

A retractable ear bud module that inhibits spooling of a microphone and ear buds in a way that will avoid binding of the microphone during retraction and dispensation of ear bud cables.

The retractable ear bud module includes a housing for holding an ear bud cable, an ear bud cable moveably mounted in the housing, the ear bud cable having a free end, at least one ear bud mounted on the free end of the ear bud cable and a microphone attached to the ear bud cable within two inches of the ear bud to inhibit spooling of the microphone.

The ear bud module includes a wireless receiver mounted in the housing for receiving audio signals from an electronic device. The wireless receiver being in electronic communication with the ear bud cable to communicate audio signals to the ear bud and to receive signals from the microphone.

A spool and pawl latch mounts in the housing for selectively retracting and dispensing the ear bud cable.

The ear bud cable has a fixed end attached to a circuit board and the ear bud cable has a middle portion wrapped around the spool to enable the ear bud cable to be selectively retracted and dispensed. The spool has a top and a bottom level and defines a slot that enables the ear bud cable to extend between the top level and the bottom level.

In a preferred embodiment, the microphone attaches within one inch of the ear bud so that when the ear bud cable is in a fully retracted configuration, neither the ear buds, nor the microphone contact the spool. In another embodiment, the microphone attaches within one half inch of the ear bud.

In yet another embodiment, the microphone attaches to the ear bud cable adjacent the ear bud. Preferably, the microphone attaches within one centimeter of the ear bud.

It can be appreciated that the microphone can also be collocated by directly attaching the microphone to the ear bud, or integrating the microphone within the ear bud. Thus, when the microphone and ear bud are collocated, they are within the distance ranges set forth in this patent application.

### BRIEF DESCRIPTION OF THE DRAWINGS

The present invention is described in terms of various examples as set forth in the drawings, in which:

FIG. 1 is a perspective view of a retractable ear bud mechanism attached to a case for an electronic device in accordance with the present invention.

FIG. 2 is a perspective view of the retractable ear bud mechanism having a hinged cover in a closed configuration.

FIG. 3 a perspective view of the retractable ear bud mechanism of FIG. 2 having the hinged cover in an open configuration.

FIG. 4 is perspectives view of an embodiment of a portion of the retractable ear bud mechanism with the microphone attached adjacent the ear bud.

FIG. 5 is a cutaway perspective view of the retractable ear bud mechanism.

### DETAILED DESCRIPTION

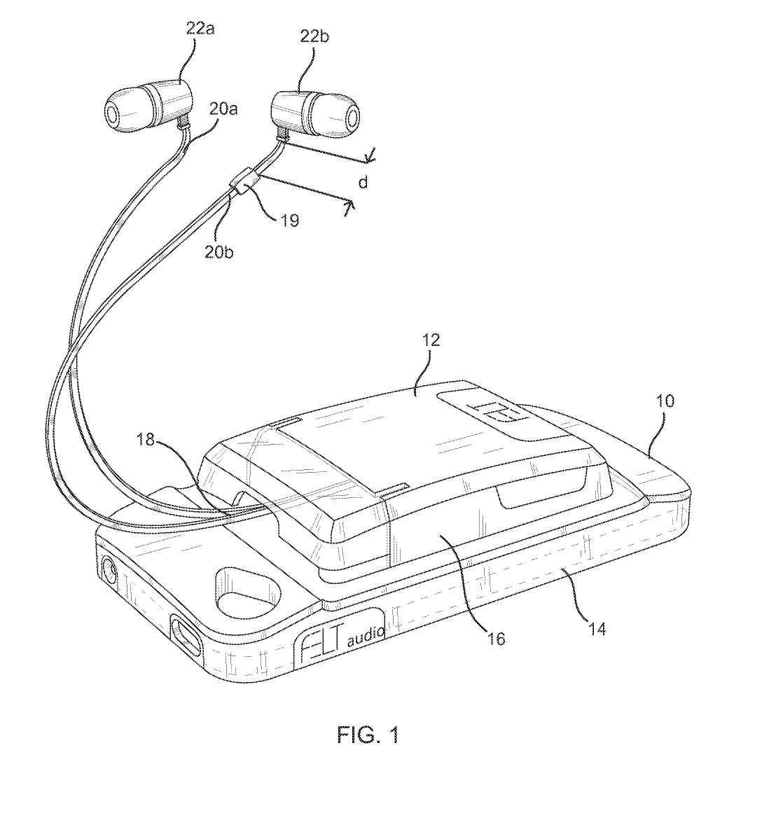

FIG. 1 shows a case 10 in accordance with the present invention and a ear bud module 12. The ear bud module 12 removeably attaches to the case 10. The case 10 holds electronic device 14 (shown with hidden lines) having an audio output capability. The electronic device 14 is preferably a telephone, the music player smart phone, a tablet computer, or other computing device having audio output capability.

In a preferred embodiment, the electronic device 14 is enabled with wireless audio output capability, for example a Bluetooth™ communication module having a radio and a processor, where the radio transmits and receives audio signals via a host-less Bluetooth™ communication protocol such as defined by the trade organization, Bluetooth SIG, and other trade organizations.

The ear bud module 12 removeably attaches to the case 10. This removable attachment can include a clipped attachment that includes a press-fit between the ear bud module 12 and the case 10. In an alternate embodiment of the invention the ear bud module 12 slidably connects to the case 10. The use of a user actuated switch supplements the press-fit and slideable connection between the ear bud module 12 and the case 10 to enable a locking connection between the case 10 and the ear bud module 12.

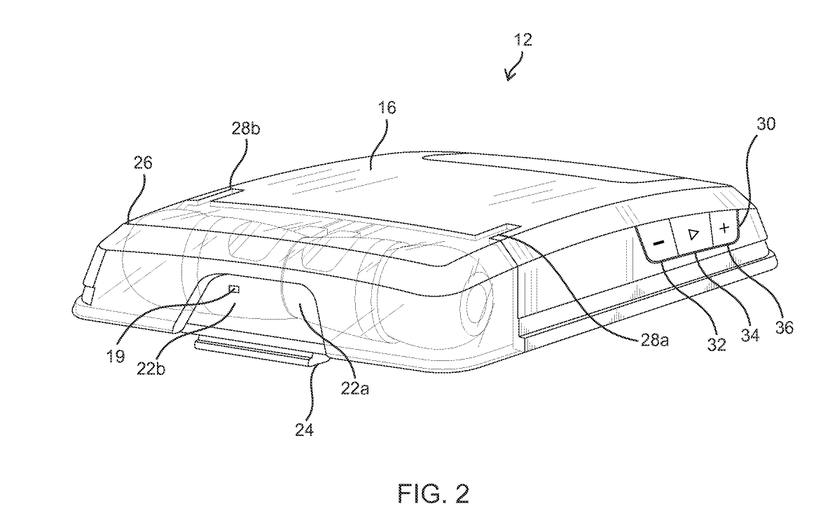

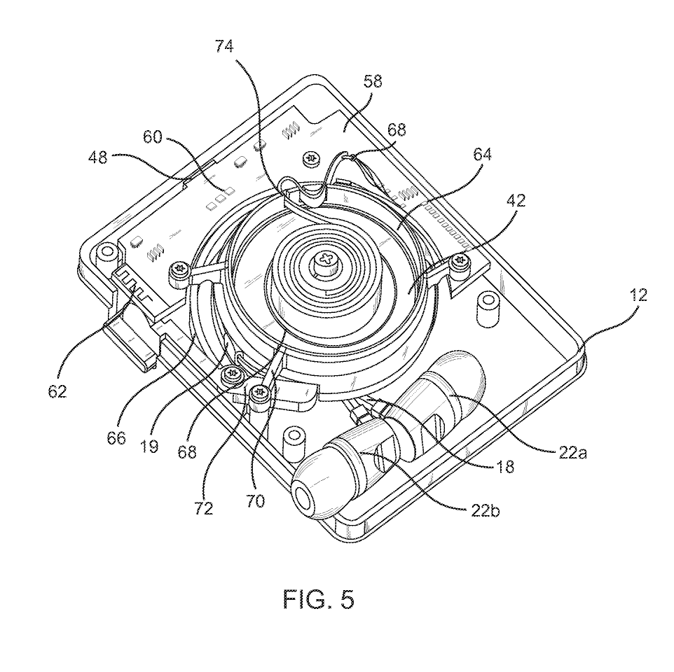

The ear bud module 12 includes a housing 16 and an ear bud cable 18, which retractably holds an ear bud cable 18 from an extended configuration as shown, to a retracted configuration shown in FIG. 2 and FIG. 5. The ear bud cable 18 has free ends 20a and 20b and ear buds 22a and 22b attached to the free ends 20a and 20b, respectively.

The ear bud cable 18 is equipped with a microphone 19 attached to one end 20b of the ear bud cable 18 to enable telephonic communication between the microphone 19 and the electronic device 14.

In one embodiment, the microphone 19 is collocated with the ear bud 22b. In a variation of this embodiment, the microphone is integrated with the ear bud 22b.

In an alternate embodiment, the microphone 19 is distanced from the ear bud 22b by a distance “d”, which is a maximum of two (2) inches. In one embodiment, the distance “d” is between one (1) and two (2) inches. In yet another embodiment, the distance “d” is less than one (1) inch. Preferably, the distance is less than a half inch.

The distance “d” between the ear bud 22b and the microphone 19 is measured between the ear bud itself, not including reinforcing sleeves commonly used with ear buds, and the surface of the microphone 19 nearest the ear bud.

Limiting the distance “d” to less than two (2) inches prevents the microphone from binding within the ear bud module 12 when the ear buds 22a and 22b are retracted.

FIG. 2 shows the ear bud module generally designated with the reference numeral 12. The ear bud module 12 includes at least one clip 24 for removeably attaching the ear bud module 12 to a case. Preferably, the ear bud module 12 has more than one clip 24. The ear buds 22a and 22b are shown in a retracted configuration.

The ear bud 22b includes a microphone 19 collocated with, and integrated with, the ear bud 22b.

The ear bud module 12 has a cover 26 mounted on the housing 16 for covering the ear buds 22a and 22b when the ear buds 22a and 22b are retracted. The cover 26 is shown closed on the housing 16. The cover 26 has two hinges 28a and 28b that assure alignment of the cover 26 on the housing 16 when the cover 26 is closed, and to enable the cover 26 to open. Preferably the cover 26 is made from transparent material to reveal the ear buds 22a and 22b when the cover 26 is closed.

The housing 16 includes a control switch 30, which includes a down volume actuator 32, and up volume actuator 36 and a skip actuator 34. The volume actuators regulate the volume of sound communicated to the ear buds 22a and 22b. The skip actuator 34 enables a user to selectively bypass an audio file when a series of audio files are streamed to the ear bud module 12 from an electronic device.

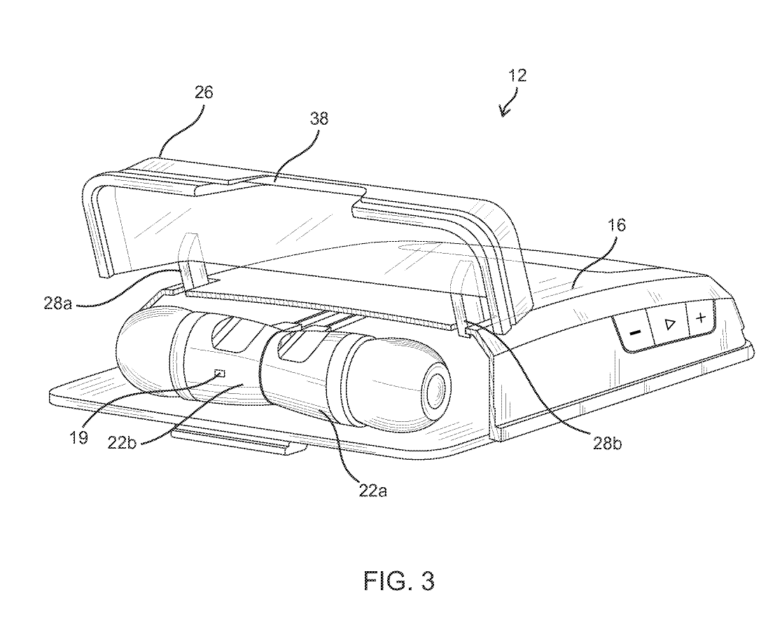

FIG. 3 shows the ear bud module 12 with the cover 26 open. The cover 26 has a handle 38 to enable a user to open and close the cover 26. As shown the handle 38 includes a recess defining an opening in the cover 26 sized to enable the finger of a user to insert into the cover 26 to grip and open the cover 26. The hinges 28a and 28b restrict the cover 26 when it opens and limit the cover opening to approximately a 90 degree angle with respect to the housing 16. The cover opening is smaller than the ear buds 22a and 22b to prevent further retraction.

Restricting the angle of the cover 26 when it opens enables the hinges 28a and 28b to be shaped so the hinges 28a and 28b only minimally protrude into the housing 16 during movement. Thus the hinges 28a and 28b are designed to minimize potential interference between the cover 38 and the ear buds 22a and 22b.

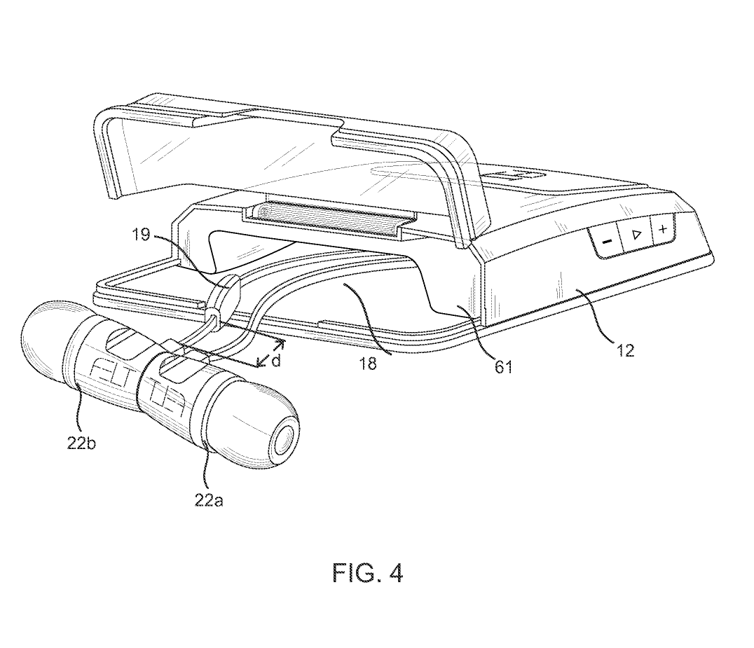

FIG. 4 shows the ear bud module 12 with the ear bud cable 18 in a partially extended configuration. The microphone 19 is positioned a distance “d” from the ear bud 22b. The distance “d” is one centimeter in this embodiment to prevent contact between the microphone and internal components that move within the ear bud module 12. In particular, positioning the microphone 19 one centimeter from the ear bud 22b prevents contact between the microphone 19 and the spool 42, the retainer 70 and pawl latch 72, which are shown in FIG. 5.

The ear bud module 12 includes an asymmetrical bridge 61 that restricts entry of the ear buds 20a and 20b further into the ear bud module 12. The asymmetrical bridge 61 guides the ear bud cable 18 into the ear bud module 12.

FIG. 5 shows an embodiment of portions of the ear bud module 12 having the ear bud cable 18 in a fully retracted configuration.

The ear bud module 12 includes the charging port 48 electrically connected with the battery 46 via a circuit board 58. The circuit board includes a processor 60 and a wireless receiver 62. The wireless receiver 62 includes a circuit board having various circuitries including a Bluetooth™ radio for transmitting and receiving signals from an electronic device equipped with Bluetooth™ capability. It can be appreciated that the wireless receiver 62 can be readily adapted to communicate via various other protocols to enable wireless communication between an electronic device and the ear bud module 12. These protocols can include UHF near field communication protocols, infrared communications protocols and other protocols capable of enabling two-way communication between an electronic device and an ear bud module. Instructions, in addition to audio signals, are communicated between the electronic device 14 (FIG. 1) and the ear bud module 12.

The ear bud cable 18 has a middle portion that wraps around a top level 64 of the spool 42 and the middle portion also wraps around the bottom level 66 of the spool 42. The spool 42 is configured with at slot 68 situated between the top level 64 and the bottom level 66 to enable the ear bud cable 18 to feed between the top level 64 and the bottom level 66 of the spool 42. As the spool 42 unwinds ear bud cable 18 slackens in the top portion 64, releasing additional length of ear bud cable 18 to the bottom level 66. A retainer 70 circumscribes the middle portion of the ear bud cable 18 that wraps around the spool 42. The retainer 70 mounts in the housing 16 with screws to retain the spool 42 in the housing and maintain alignment of the spool 42 in the housing 16.

The ear bud cable 18 has a fixed end 68 that is hard wired to the circuit board 58 to assure integrity of the audio signals communicated from the wireless receiver 62 of the circuit board 58 to the ear buds 22a and 22b. Preferably the hard wired connection between the circuit board 58 and the fixed end 68 is a solder joint. The retainer 70 includes at least one locking channel 74 that locks the ear bud cable 18 near the fixed end 68 of the ear bud cable 18, to prevent the solder joint from breaking when the ear bud cable is in the fully extended configuration such as during use of the ear buds 22a and 22b.

Although a hard wired connection between the fixed end 68 of the ear bud cable 18 and the circuit board 58 is described, alternate connections are possible; including a plug or other mechanism for interconnecting an ear bud cable 18 to a circuit board 58 that assures signal integrity can be used.

The ear bud module 12 includes a pawl latch 72 for selective locking the spool 42 when the ear bud cable 18 is in the fully retracted configuration and when the ear bud cable 18 is in the extended configuration.

The microphone 19 lies within two inches of the ear bud 22b on the surface of the bottom level 66 of the spool 42. The microphone 19 is tangentially aligned with the spool 42 to minimize any potential for entanglement with portions of the ear bud cable 18. In operation, the microphone 19 cannot be wound further into the spool. Tangential alignment with the spool 42 by the microphone 19 prevents portions of the ear bud cable 18 from winding over the microphone.

While the present invention is disclosed in terms of various embodiments, including preferred embodiments, it can be appreciated that the true scope of the invention is defined only by the appended claims.

1. A retractable ear bud module, comprising:
a housing for holding an ear bud cable;
an ear bud cable moveably mounted in the housing, the ear bud cable having a free end;
at least one ear bud mounted on the free end of the ear bud cable and a microphone attached to the ear bud cable within two inches of the ear bud;
a wireless receiver mounted in the housing for receiving audio signals from an electronic device, the wireless receiver being in electronic communication with the ear bud cable to communicate audio signals to the ear bud and to receive signals from the microphone; and
a spool mounted in the housing for selectively retracting and dispensing the ear bud cable.

2. The ear bud module as set forth in claim 1, wherein the ear bud cable has a fixed end attached to a circuit board, the ear bud cable has a middle portion wrapped around the spool to enable the ear bud cable to be selectively retracted and dispensed.

3. The ear bud module as set forth in claim 2, wherein the spool has a top and a bottom level and defines a slot that enables the ear bud cable to extend between the top level and the bottom level.

4. The ear bud module as set forth in claim 3, wherein the microphone attaches within one inch of the ear bud.

5. The ear bud module as set forth in claim 3, wherein the microphone attaches within one half inch of the ear bud.

6. The ear bud module as set forth in claim 3, wherein the microphone attaches within one centimeter of the ear bud.

7. A case having a removable ear bud module, comprising:
a case for holding an electronic device having audio-output capability;
a housing for holding an ear bud cable, the housing being attachable to the case;
an ear bud cable moveably mounted in the housing, the ear bud cable having a free end;
at least one ear bud mounted on the free end of the ear bud cable;
a wireless receiver mounted in the housing for receiving audio signals from the electronic device, the wireless receiver being in electronic communication with the ear bud cable to communicate audio signals to the ear bud;
a microphone mounted on the ear bud cable in electronic communication with the wireless receiver, the microphone mounts within two inches of the ear bud;
a retraction mechanism mounted in the housing for selectively retracting and dispensing the ear bud cable.

8. The case as set forth in claim 7, wherein the housing has clips for removeably attaching the housing to the case, the case is configured for holding the electronic device, the electronic device being chosen from the group consisting of: a cellular telephone, a audio player, and a notepad computing device.

9. The ear bud module as set forth in claim 7, wherein the microphone attaches within one inch of the ear bud.

10. The ear bud module as set forth in claim 7, wherein the microphone attaches within one half inch of the ear bud.

11. The ear bud module as set forth in claim 7, wherein the microphone attaches within one centimeter of the ear bud.

12. A retractable ear bud module, comprising:
a housing for holding an ear bud cable;
an ear bud cable retractably mounted in the housing, the ear bud cable having a free end with an ear bud and a microphone;
wherein the microphone is distanced by no more than two inches from the ear bud.

13. A retractable ear bud module as set forth in claim 12, wherein the housing includes a rotatable spool mounted in the housing for selectively retracting and dispensing the ear bud cable,
wherein when the ear bud cable is retracted, the microphone is distanced from the spool.

14. A retractable ear bud module as set forth in claim 12, wherein the housing includes a rotatable spool mounted in the housing for selectively retracting and dispensing the ear bud cable,
wherein when the ear bud cable is retracted, the microphone lies tangentially on the spool.

15. The ear bud module as set forth in claim 13, wherein the microphone attaches within one inch of the ear bud.

16. The ear bud module as set forth in claim 13, wherein the microphone attaches within one half inch of the ear bud.

17. The ear bud module as set forth in claim 13, wherein the microphone attaches within one centimeter of the ear bud.

18. The ear bud module as set forth in claim 13, wherein the microphone is collocated with the ear bud.

19. The ear bud module as set forth in claim 13, wherein the microphone is integrated with the ear bud.
